(19) United States
(12) Patent Application Publication
(10) Pub. No.: US 2015/0003132 A1
(43) Pub. Date: Jan. 1, 2015

(54) INVERTER WITH LESS SNUBBER CAPACITORS

(71) Applicant: KONINKLIJKE PHILIPS N.V., Eindhoven (NL)

(72) Inventors: Oliver Woywode, Hamburg (DE); Peter Luerkens, Aachen (DE)

(21) Appl. No.: 14/371,775

(22) PCT Filed: Jan. 8, 2013
(86) PCT No.: PCT/IB2013/050150

§ 371 Date: Jul. 11, 2014

Related U.S. Application Data
(60) Provisional application No. 61/585,767, filed on Jan. 12, 2012.

(51) Int. Cl. H02M 7/5387

(52) U.S. Cl. CPC H02M 7/5387
USPC 363/132

(57) ABSTRACT

An electrical inverter 18 for transforming an DC current into an AC current comprises at least one half-bridge 54. The half bridge 54 comprises at least two series connected semiconductor switches 58a, 58b, 58c, 58d inter-connecting an input terminal 54, 56 with an output terminal 50 of the inverter 18. A snubber capacitor 62a, 62b is connected in parallel to at least two semiconductor switches 58a, 58b, 58c, 58d of the half bridge 54.

### FIELD OF THE INVENTION

This invention relates to an electrical inverter, for example for an X-ray device, and a method, a computer program and a computer-readable medium for switching an electrical inverter. The invention further relates to a high voltage device.

### BACKGROUND OF THE INVENTION

In many high power devices like X-ray imaging devices, an AC input voltage from an electrical grid is rectified and transformed into an AC output voltage that may have a different frequency and magnitude as the AC input voltage. The AC output voltage may be used for supplying a load. For example, in specific X-ray devices the AC output voltage is supplied to a step-up transformer, rectified and used for operating an X-ray tube.

In particular, in such high power applications, mains for a three-phase AC input voltage may be connected to a B6-diode-rectifier (three half-bridges) as front-end, which generates an unregulated DC voltage supplied to a DC link. The AC input voltage range is expected from 380-480V AC depending on the mains voltage of the specific country. Taking into account the mains impedances and the voltage tolerances this may result in a DC link voltage range of nearly 400-750V. In order to utilize general purpose 600V power semiconductors in the following high frequency switching inverter (for example a H-bridge-inverter), an additional DC-DC converter, for example a buck converter, between the diode rectifier and the inverter may be necessary to stabilize the DC-link voltage (for example to 400V) that is input to the inverter.

EP 2 286 423 A1 shows such an X-ray device with a two-level inverter for power supply.

### SUMMARY OF THE INVENTION

For lowering the switching losses, the DC-DC converter and the H-bridge inverter may be substituted by a multi-level inverter, for example a 5-level inverter. This 5-level inverter may generate the same output power in the same frequency range within an uncontrolled DC-link voltage range of 400-750 V. To reduce the switching losses the inverter may be operated in the Zero-Voltage-Switching mode (ZVS mode).

A multi-level half-bridge of a 5-level-inverter may comprise at least four semiconductor switches in series. To obtain zero voltage switching a snubber capacitor may be placed in parallel to each of the four switches. This may sometimes cause hard switching.

It may be an object of the invention to provide an electrical inverter with low switching losses.

This object may be achieved by the subject-matter of the independent claims. Further exemplary embodiments are evident from the dependent claims and the following description.

An aspect of the invention relates to an electrical inverter for transforming an DC current into an AC current.

According to an embodiment of the invention, the inverter comprises at least one half-bridge. The half bridge comprises at least two series connected semiconductor switches interconnecting an input terminal with an output terminal of the inverter. A snubber capacitor is connected in parallel to the at least two series connected semiconductor switches of the half bridge.

It may be a gist of the invention, that only one snubber capacitor is connected in parallel to two semiconductor switches of the half bridge instead of connecting a snubber capacitor in parallel to each of the two semiconductor switches. With only one snubber capacitor, the snubber capacitor may be discharged even in the case, when only one of the two switches is closed.

In such a way, hard switching may be avoided if just one capacitor is placed in parallel across two semiconductor switches. For example, one capacitor may be placed (connected) in parallel to the two upper switches and one capacitor in parallel to the two lower switches of a half bridge. This may avoid the hard switching condition and may reduce the number of snubber capacitors. Hence, this solution may guarantee that the capacitor is discharged prior turn-on of its corresponding two semiconductor switches.

A further aspect of the invention relates to a method for switching an electrical inverter.

According to an embodiment of the invention, the method comprises the step of: switching semiconductor switches in the half bridge in such a way that a voltage change at the output terminal of the half bridge is generated that has an opposite direction with respect to a sign of a current flowing from the output terminal to a load.

Further aspect of the invention relates to a computer program for controlling an electrical inverter, which, when being executed by a processor, is adapted to carry out the method as described in the above and in the following and a computer-readable medium, in which such a computer program is stored. A computer-readable medium may be a floppy disk, a hard disk, an USB (Universal Serial Bus) storage device, a RAM (Random Access Memory), a ROM (Read Only memory) and an EPROM (Erasable Programmable Read Only Memory). A computer readable medium may also be a data communication network, e.g. the Internet, which allows downloading a program code.

A further aspect of the invention relates to a high voltage device, for example an X-ray device.

According to an embodiment of the invention, the high voltage device comprises an input rectifier for rectifying an input voltage into a DC voltage; an electrical inverter as described in the above and in the following for converting the DC voltage into an AC output voltage and an inductive load for receiving the output voltage of the inverter. In particular, an inductive load may maintain a current at the output of the inverter and may support the zero voltage switching of the semiconductor switches of the inverter.

It has to be understood that features of the method as described in the above and in the following may be features of the device as described in the above and in the following.

These and other aspects of the invention will be apparent from and elucidated with reference to the embodiments described hereinafter.

### BRIEF DESCRIPTION OF THE DRAWINGS

FIG. 1 shows an X-ray device according to an embodiment of the invention.

FIG. 2 shows a circuit diagram of an inverter.

FIG. 3 shows a circuit diagram of an inverter according to an embodiment of the invention.

FIG. 4 shows a voltage-time diagram of the output of half bridges and an inverter according to an embodiment of the invention.

In principle, identical parts are provided with the same reference symbols in the figures.

### DETAILED DESCRIPTION OF EMBODIMENTS

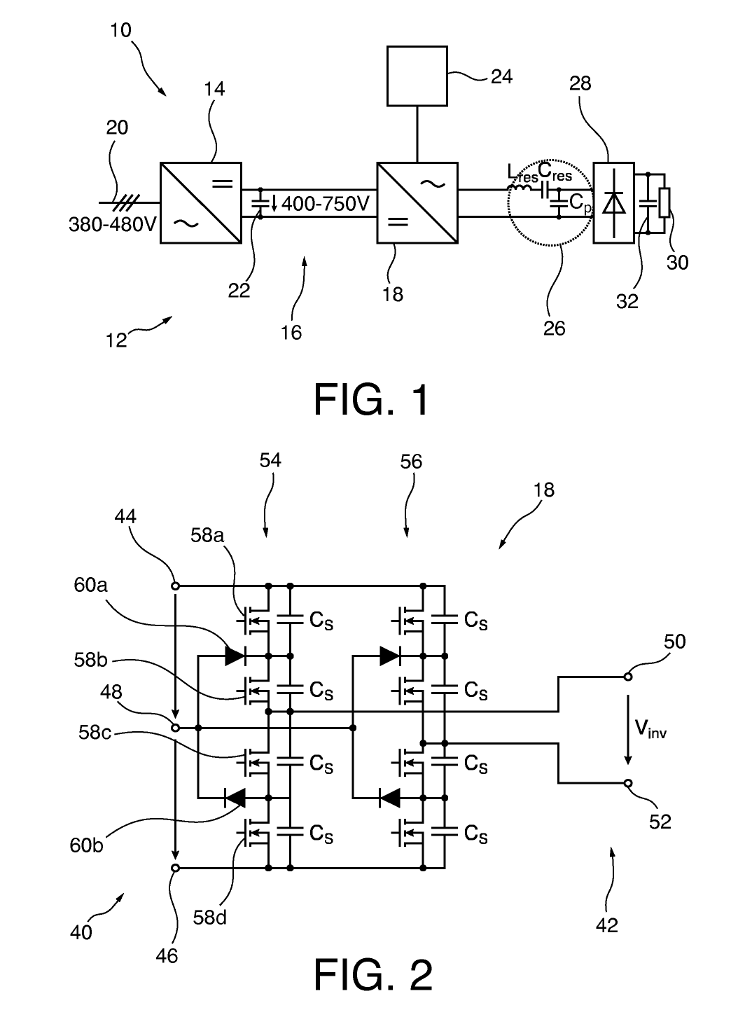

FIG. 1 shows an X-ray device 10 with an electrical energy supply system 12 comprising an input rectifier 14, a DC-link 16 and a 5-level inverter 18.

The rectifier 14 may be a (passive) B6 rectifier with three half-bridges and may be connected to a power grid 20, for example with three phases. The power grid may have a voltage between 360 V to 480 V depending on the general grid voltage of specific countries. The rectifier 14 rectifies the AC voltage from the power grid 20 and supplies the generated DC voltage into the DC-link 16.

The DC-link 16 interconnects the rectifier 14 and the inverter 18 and has a capacitor 22 for storing electrical energy.

The inverter 18 is an active element and is controlled by a controller 24. In particular, the inverter 18 has active power semiconductor switches that are switched on and off by the controller 24 in such a way that a 5-level AC output voltage from the DC voltage is generated. The 5-level AC output voltage is supplied to a resonant circuit 26. With respect to a (conventional) energy supply system that has a DC-DC converter and an H-bridge inverter, the combination of the DC-DC converter and the H-bridge inverter is substituted by the 5-level inverter 18. The 5-level-inverter 18 may generate the same output power in the same frequency range within an uncontrolled DC-link voltage range of 400 V to 750 V. For reducing the switching power losses, the controller 24 may be adapted to operate the inverter in a Zero-Voltage-Switching mode.

The X-ray device 10 further comprises the resonant circuit 26 or resonant tank 26, an output rectifier 28 and a load 30 connected in parallel to a capacitor 32 at the output of the output rectifier 28. In general, the element 28 may be or may comprise a combination of a rectifier and a high voltage cascade, for example various voltage doublers.

The load 30 may comprise an X-ray tube.

The resonant circuit 26 comprises an inductor Lᵣₑₛ and a capacitor Cᵣₑₛ connected in series with a capacitance C_{P} in parallel to the output rectifier 28 and may be seen as an LCC resonant tank 26. The resonant circuit 26 may be adapted for filtering out higher harmonics of the AC output voltage of the inverter 18 and thus may smooth the AC output voltage of the inverter 28. Furthermore, the resonant tank circuit 26 may be designed for the lowest value of the uncontrolled DC-link voltage and 600 V semiconductors may be used.

The rectifier 28 may be a (passive) B2 rectifier with two half bridges.

According to an embodiment of the invention, the electrical energy supply system 12 comprises an output rectifier 28 for rectifying the AC output voltage to a DC output voltage to be supplied to the load 30.

According to an embodiment of the invention, a high voltage device 10, for example an X-ray device 10, may comprise an input rectifier 14 for rectifying an input voltage into an DC voltage; an electrical inverter 18 for converting the DC voltage into a 5-level output voltage; and an inductive load, for example an X-ray tube 30 and/or an resonant filter 26, for receiving the output voltage of the inverter 18.

According to an embodiment of the invention, the high voltage device 10 comprises further a controller 24 adapted for controlling the inverter 18 and for switching the semiconductor switches 58a, 58b, 58c, 58d.

FIG. 2 shows a circuit diagram of a 5-level inverter 18.

On the input side 40, the inverter 18 is connected to two input terminals 44, 46 providing a positive DC-link voltage +V_{DC} and a negative DC-link voltage −V_{DC} with respect to a neutral point 48. On the outputs side 42, the inverter provides an AC output voltage Vᵢₙᵥ between two output terminals 50, 52.

The inverter 18 comprises two half-bridges 54, 56 each of which is adapted to generate three voltage levels (−V_{DC}, 0+V_{DC}) at the respective output terminal 50, 52. The half-bridges 54, 56 are connected in parallel to the two input terminals 44, 46. Together, the two half bridges 54, 56, and therefore the inverter 18 are adapted to generate five voltage levels (−2V_{DC}, −V_{DC}, 0, +V_{DC}, +2V_{DC},).

The half bridges 54, 56 are equally designed, so the following description with respect for the half bridge 54 will also apply for the half bridge 56.

The half bridge 54 comprises four semiconductor switches 58a, 58b, 58c, 58d connected in series between the 2 terminals 44, 46 and two clamping diodes 60a, 60b connected to the neutral point 48 and in between the upper two semiconductor switches 58a, 58b and in between the lower two semiconductor switches 58c, 58d, respectively. The output terminal 50 is connected to the middle of the half bridge 54, i.e. between the semiconductor switches 58b, and 58c. The half bridges 54, 56 and therefore the inverter 18 are neutral point clamped.

For connecting the output terminal 50 with the positive input terminal 44, the upper two semiconductor switches 58a, 58b may be turned on and the lower two semiconductor switches 58c, 58d may be turned off. This may be indicated by (++−−). In this case, the half-bridge 54 may provide the voltage +V_{DC} at the terminal 50.

For connecting the output terminal 50 with the negative input terminal 46, the upper two semiconductor switches 58a, 58b may be turned off and the lower two semiconductor switches 58c, 58d may be turned on. This may be indicated by (−−++). In this case, the half-bridge 54 may provide the voltage −V_{DC} at the terminal 50.

For connecting the output terminal 50 with the neutral point 48, the outer two semiconductor switches 58a, 58d may be turned off and the inner two semiconductor switches 58b, 58c may be turned on. This may be indicated by (−++−). In this case, the half-bridge 54 may provide the voltage 0 at the terminal 50.

The other half-bridge 56 may be switched in the same way. For example, when the half-bridges 54, 56 are switched in such a way that the terminal 50 is connected with the terminal 44 and the terminal 52 is connect with the terminal 46, the output voltage Vᵢₙᵥ is +2V_{DC}. The output voltages of the two half-bridges 54, 56 add up to the output voltage Vᵢₙᵥ of the inverter 18.

It may be possible that the inverter 18 has only one half-bridge 54 and that the second output terminal 52 is directly connected to the neutral point 48. In this case, the inverter is adapted to generate the output voltage levels V_{DC}, −V_{DC} and 0.

According to an embodiment of the invention, an electrical inverter 18 for transforming an DC current into an AC current comprises at least one half-bridges 54. The half bridge 54 may comprise at least two series connected semiconductor switches 58a, 58b, 58c, 58d interconnecting an input terminal 44, 46 with an output terminal 50 of the inverter 18.

According to an embodiment of the invention, the inverter comprises at least two half-bridges 54, 56 connected in parallel with respect to two input terminals 44, 46 of the inverter 18.

According to an embodiment of the invention, the electrical inverter is a 5-level inverter 18 adapted to generate a negative full voltage −2V_{DC} and a positive full voltage +2V_{DC}, a negative half voltage −V_{DC} and a positive half voltage +V_{DC} and no voltage 0 V between two output terminals 50, 52 as output voltage Vᵢₙᵥ.

A snubber capacitor C_{S} is connected in parallel to each semiconductor switch 58a, 58b, 58c, 58d to obtain zero voltage switching. When a snubber capacitor C_{S} is connected in parallel to a semiconductor switch, the voltage across the semiconductor during turn-off may rise slower, which may support the zero voltage switching of the semiconductor. Zero voltage switching may mean that no or nearly no voltage is provided at semiconductor switch, when it is switched. In particular, when a load 26, 28, 30 is connected to the inverter 18 which comprises an inductor, which tries to maintain a supplied current, the current from the inductor will substantially flow into the capacitor C_{S} and not into the semiconductor switch.

However, in the case when the switching configuration is such that the output voltage of a half bridge 54 or 56 starts to be or should become zero, hard switching, i.e. switching of semiconductor switches without zero voltage may be caused. In particular, hard switching occurs when an active semiconductor switch turns on while its corresponding snubber capacitor C_{S} has not been discharged before. For example, consider the case, when the first half-bridge 54 is in the switching state (++−−) and the second half-bridge 56 in (−−++), i.e. the inverter 18 generates an output voltage Vᵢₙᵥ of +2V_{DC} and load current flows in the direction from terminal 50 to the load. In this case both capacitors C_{S} in parallel to the switches 58a, 58b are discharged as the voltages across the respective switches are zero. However, the voltage at the snubber capacitors of switches 58c and 58d are charged to V_{DC} each. Eventually, after transitional switching states, the first-half-bridge 54 is switched to (−++−), for lowering the output voltage of this half bridge 54 to the neutral voltage and thus Vᵢₙᵥ to +V_{DC}. The new state is now determined by snubber capacitors of switches 58a and 58d being charged to a voltage of V_{DC} while the snubber capacitors of switches 58b and 58d are discharged. In order to achieve this by ZVS switching, a procedure has to be found which allows establishing this situation before switched 58b and 58c are turned on. This is not possible with the circuit of FIG. 2.

A procedure which comes close to it starts with turning switch 58a off. Then ⅔ of the load current moves from switch 58a into its snubber capacitor, while one third of the current moves to the series connection of the snubber capacitors of switches 58c and 58d. The snubber capacitor of 58b does not receive a charging current as switch 58b still short circuits its snubber capacitor. From now on, the voltage at terminal 50 drops until the voltage level of the neutral terminal 48 is reached. Then diode 60a takes over the entire load current so that voltages in the snubber capacitors come to rest. At this time, the snubber capacitors of switches 58c and 58d are charged to V_{DC}/2 each. There is no other choice now, than to turn on switch 58c before the load current direction changes and thus incurring hard switching on the mismatched voltages of snubber capacitors of switch 58c and 58d.

However, ZVS switching of a half bridge 54, 56 between the full positive and full negative voltage without using the neutral level, and thus producing inverter output voltage levels of +2V_{DC}, −2V_{DC} and 0, is well possible in the way known by those who are familiar with the state of the art.

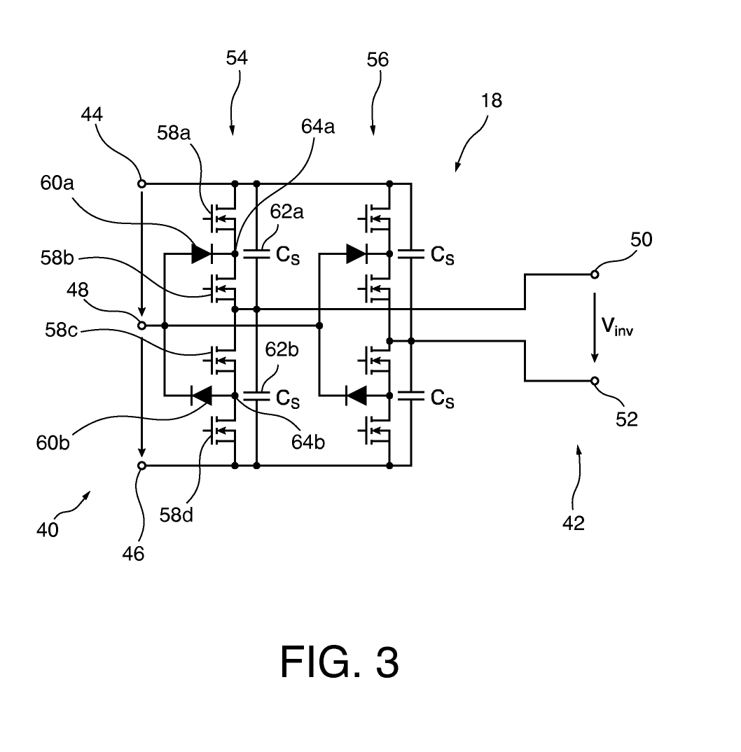

FIG. 3 shows a circuit diagram of a further 5-level inverter 18, which, except with respect to the capacitors C_{S}, is equally designed as the inverter 18 of FIG. 2.

In the inverter 18 of FIG. 3, the snubber capacitors C_{S} are connected in parallel to two semiconductor switches. In particular, the snubber capacitor 62a is connected in parallel to the upper semiconductor switches 58a, 58b and the snubber capacitor 62b is connected in parallel to the lower semiconductor switches 58c, 58d. In such a way, the snubber capacitors 62a, 62b are directly connecting the output terminal 50 with the respective input terminal 44, 46. The connection 64a, 64b of the respective diodes 60a, 60b between the two semiconductor switches 58a, 58b (58c, 58d respectively) is not directly connected to the snubber capacitor 62a, 62b.

A snubber capacitor 62a, 62b may be determined by its desired corresponding voltage gradient, which may be about 4 V per ns. For example a snubber capacitor 62a, 62b may have a capacity of about 4 nF, when the currents at the moment of turn-off are about 1 A.

According to an embodiment of the invention, a snubber capacitor 62a, 62b is connected in parallel to at least two semiconductor switches 58a, 58b, 58c, 58d of a half bridge 54, 56.

According to an embodiment of the invention, a neutral point terminal 48 is connected between the at least two semiconductor switches 58a, 58b, 58c, 58d of the half bridge 54, 56, in particular via a diode 60a, 60b, to the connection 64a, 64b.

According to an embodiment of the invention, the connection 64a, 64b to the neutral point terminal 48 between the at least two semiconductor switches 58a, 58b, 58c, 58d is not directly connected to the snubber capacitor 62a, 62b.

According to an embodiment of the invention, the snubber capacitor 62a, 62b is directly connected to the input terminal 44, 46 and to the output terminal 50, 52.

According to an embodiment of the invention, the snubber capacitor 62a, 62b is connected in parallel to two semiconductor switches 58a, 58b, 58c, 58d.

This may be generalized to inverter topologies with more than 5 levels, for example 7, 9, . . . levels. In these cases a snubber capacitor may be connected in parallel to three, four, . . . semiconductor switches.

According to an embodiment of the invention, each half bridge 54, 56 interconnects a positive input terminal 44 with a negative input terminal 46 and each half bridge 54, 56 comprises at least two upper series connected semiconductor switches 58a, 58b interconnecting the positive terminal 44 with an output terminal 50, 52 and at least two lower series connected semiconductor switches 58c, 58d interconnecting the negative terminal 46 with the output terminal 50, 52.

According to an embodiment of the invention, a neutral point terminal 48 is connected between the at least two upper semiconductor switches 58a, 58b and between the at least two lower semiconductor switches 58c, 58d.

According to an embodiment of the invention, an upper snubber capacitor 62a is connected in parallel to the at least two upper semiconductor switches 58c, 58d and a lower snubber capacitor 62b is connected in parallel to the at least two lower semiconductor switches 58c, 58d.

According to an embodiment of the invention, a (or each) half-bridge 54, 56 has only two snubber capacitors 62a, 62b.

According to an embodiment of the invention, the electrical inverter 18 or at least one of the half bridges 54, 56 has at most half as much snubber capacitors 62a, 62b as semiconductor switches 58a, 58b, 58c, 58d.

The placing of one capacitor 62a, 62b across or in parallel to the two upper switches 58a, 58b and one capacitor 62a, 62b in parallel to the two lower switches 58c, 58d may guarantee that the capacitor 62a, 62b is discharged prior turn-on of its corresponding two switches. Furthermore, the number of snubber capacitors 62a, 62b may be reduced.

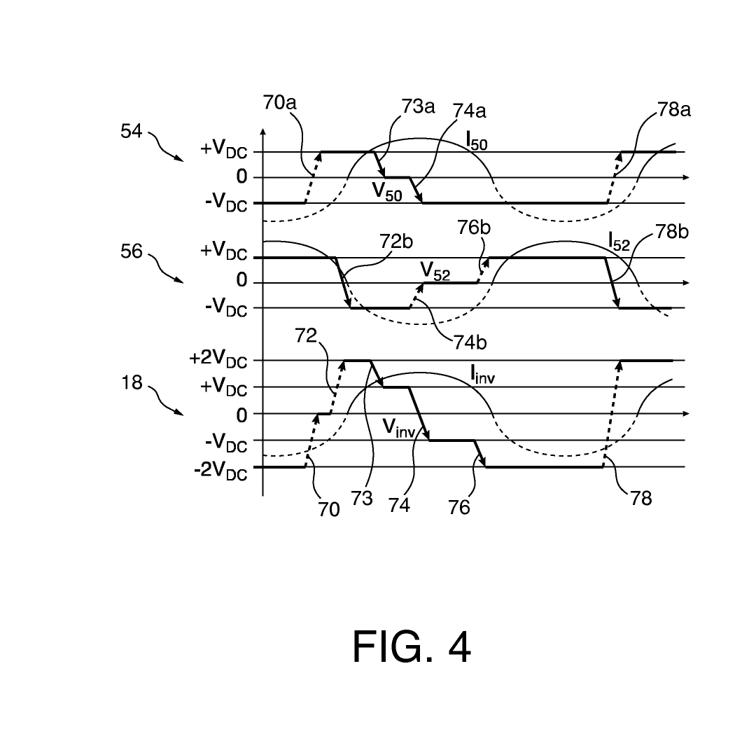

FIG. 4 shows a voltage-time diagram of the outputs of the inverter 18 of FIG. 3 and the respective two half-bridges 54, 56. The vertical axis of the diagram shows the voltage and the current. The horizontal axis the time.

FIG. 4 shows the output voltage V₅₀ and the output current I₅₀ of the first half-bridge 54 at terminal 50, the output voltage V₅₂ and the output current I₅₂ of the second half-bridge 54 at terminal 52 as well as the output voltage Vᵢₙᵥ and the output current Iᵢₙᵥ of the inverter 18 between the terminals 50, 52.

Since the switching instants 70a, 72b, 73a, 74a, 74b, 76b, 78a, 78b of the two half-bridges 54, 56 are independent from each other, the two half bridges 54, 56 may be switched simultaneously, as is the case for the switching instants 74a, 74b in the middle of the second half wave or for the last switching instants 78a, 78b. The shown sequence of switching instants is only an example of a possible switching sequence.

The switching instants admissible for ZVS are switching instants with a voltage change opposite to the sign of the respective current I₅₀, I₅₂ of the half-bridge 54, 56. The sign of the current I₅₀, I₅₂ may be defined by setting the current to a load current, i.e. the sign is positive, when the current I₅₀, I₅₂ flows out of the half-bridge 50, 52 in direction to the load 26, 28, 30. Therefore, the current I₅₂ is inverse to the current I₅₀.

For example, during the switching instant 70a of the first half-bridge 54, the sign of the current I₅₀ is negative and the voltage is from −V_{DC} to +V_{DC}, i.e. +2V_{DC}.

As a further example, during the switching instant 78b of the second half-bridge 54, the sign of the current I₅₂ is positive and the voltage change is from +V_{DC} to −V_{DC}, i.e. −2V_{DC}.

According to an embodiment of the invention, the semiconductor switches 58a, 58b, 58c, 58d in the first-half bridge 54 are switched in such a way that a voltage change at the first output terminal 50 is generated that has an opposite direction with respect to a sign of a current flowing from the first output terminal 50 through a load 26, 30 to the second output terminal 52.

According to an embodiment of the invention, the semiconductor switches in the second half bridge are switched in such a way that a voltage change at the second output terminal 52 is generated that has an opposite direction with respect to a sign of a current flowing from the second output terminal 52 through the load 26, 30 to the first output terminal 50.

In general for the first half bridge, when the current I₅₀ is positive, the voltage V₅₀ may be switched from +V_{DC} to 0, from 0 to −V_{DC} and from +V_{DC} to −V_{DC}, and when the current I₅₀ is negative, the voltage V₅₀ may be switched from −V_{DC} to 0, from 0 to +V_{DC} and from −V_{DC} to +V_{DC}.

For example, when switching V₅₀ from +V_{DC} to 0 with positive current I₅₀, the semiconductor switches 58a, 58b, 58c, 58d may be may switched in the following way as described above: First (++−−) to (−+−−), then when the voltage at connection 62a has reached the neutral voltage to (−++−). In this case, during switching on the switch 58c between (−+−−) and (−++−), the capacitors 62a and 62b have the appropriate voltage levels and the ZVS condition is respected.

When switching V₅₀ from 0 to +V_{DC} with positive negative current I₅₀, the semiconductor switches may switched 58a, 58b, 58c, 58d in the following way: First (−++−) to (−+−−), then when the voltage at the connection 64a has reached V_{DC} to (++−−). In this case, during switching on the switch 58b between (−+−−) and (++−−), the capacitors 62a and 62b have the appropriate voltage levels and the ZVS condition is respected.

Switching transitions with −V_{DC} result in a similar way with reversed sings for voltage and current.

Switching instants from +V_{DC} to −V_{DC} may be generated from a sequence of switchings for example by switching from +V_{DC} to 0 to −V_{DC}, i.e. with the sequence (++−−) to (−+−−) to (−++−) to (−−+−) to (−−++). In this case also other sequences are possible, for example (++−−) to (−−−−) to (−−++), which will produce the same current and voltage values at the switches 58a, 58b, 58c, 58d.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art and practicing the claimed invention, from a study of the drawings, the disclosure, and the appended claims. In the claims, the word “comprising” does not exclude other elements or steps, and the indefinite article “a” or “an” does not exclude a plurality. A single processor or controller or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

1. An electrical inverter for transforming an DC current into an AC current,
the inverter comprising at least one half-bridge;
the half bridge comprising at least two series connected semiconductor switches interconnecting an input terminal with an output terminal of the inverter
wherein a snubber capacitor is connected in parallel to the at least two series connected semiconductor switches of the half bridge;
wherein a neutral point terminal is connected via a diode to a connection between the at least two series connected semiconductor switches of the half bridge;
wherein the connection between the at least two semiconductor switches is not directly connected to the snubber capacitor.

2. (canceled)

3 . The electrical inverter of claim 1,
wherein the snubber capacitor is directly connected to the input terminal and to the output terminal.

4. The electrical inverter of claim 1,
wherein the snubber capacitor is connected in parallel to two semiconductor switches.

5. The electrical inverter of claim 1,
wherein the half bridge interconnects a positive input terminal with a negative input terminal and the half bridge comprises at least two upper series connected semiconductor switches interconnecting the positive terminal with an output terminal and at least two lower series connected semiconductor switches interconnecting the negative terminal with the output terminal,
wherein a neutral point terminal is connected between the at least two upper semiconductor switches and between the at least two lower semiconductor switches by means of diodes;
wherein an upper snubber capacitor is connected in parallel to the at least two upper semiconductor switches;
wherein a lower snubber capacitor is connected in parallel to the at least two lower semiconductor switches.

6. The electrical inverter of claim 1,
wherein the half-bridge has only two snubber capacitors.

7. The electrical inverter of claim 1,
wherein the electrical inverter has at most half as much snubber capacitors as semiconductor switches.

8. The electrical inverter of claim 1,
wherein the inverter comprises two half bridges;
wherein the electrical inverter is a 5-level inverter adapted to generate a negative full voltage (−2V_{DC}) and a positive full voltage (+2V_{DC}), a negative half voltage (−V_{DC}) and a positive half voltage (−V_{DC}) and no voltage (0 V) between two output terminals as output voltage.

9. A method for switching an electrical inverter according to claim 1, the method comprising the step of:
switching semiconductor switches in the half bridge in such a way that a voltage change at the output terminal of the half bridge is generated that has an opposite direction with respect to a sign of a current flowing from the output terminal to a load.

10. A computer program for controlling an electrical inverter, which, when being executed by a processor, is adapted to carry out the steps of the method of claim 9.

11. A computer-readable medium, in which a computer program according to claim 11 is stored.

12. A high voltage device, for example an X-ray device, comprising:
an input rectifier for rectifying an input voltage into an DC voltage;
an electrical inverter according to claim 1 for converting the DC voltage into an AC output voltage;
an inductive load for receiving the output voltage of the inverter.

13. The high voltage device of claim 12, further comprising:
a controller adapted for executing the method for switching an electrical inverter.
